(19) United States
(12) Patent Application Publication
(10) Pub. No.: US 2006/0244407 A1
(43) Pub. Date: Nov. 2, 2006

(54) Stepper motor encoding systems and methods

(75) Inventors: Dale A. Lawrence, Louisville, CO (US); Lucy Y. Pao, Boulder, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Regents of the University of Colorado, Boulder, CO (US)

(21) Appl. No.: 11/388,413

(22) Filed: Mar. 23, 2006

Related U.S. Application Data
(60) Provisional application No. 60/664,725, filed on Mar. 24, 2005.

(51) Int. Cl. G05B 19/40

(52) U.S. Cl. 318/685

(57) ABSTRACT

A method of producing a smoother torque from a multi-pole motor is described. The method includes determining an angular position of a rotor of the multi-pole motor, and producing a current to drive the multi-pole motor. The current is controlled based on the angular position of the rotor so as to produce a smoother torque, without the substantially sinusoidal characteristics of torque produced by a steady current. An apparatus is described which can employ methods of the invention to provide smoother torque from a multi-pole motor.

### CROSS-REFERENCE TO RELATED APPLICATIONS

This application claims priority from co-pending U.S. Provisional Patent Application No. 60/664,725 filed Mar. 24, 2005, entitled “Multiple Degree Of Freedom Haptic System With Low Cost, High Fidelity, Reduced Footprint,” which is hereby incorporated by reference in its entirety, as if set forth in full in this document, for all purposes.

### STATEMENT AS TO RIGHTS TO INVENTIONS MADE UNDER FEDERALLY SPONSORED RESEARCH OR DEVELOPMENT

The United States Government has certain rights in this invention pursuant to NSF Grant Nos. IIS 9711936 and HRD 0095944.

### APPENDIX

This application includes an appendix that forms part of this application and is incorporated herein by reference for all purposes:

APPENDIX I: “Unwarping Encoder Ripple in Low Cost Haptic Interfaces,” by Dale A. Lawrence, Lucy Y. Pao, and Sutha Aphanuphong.

### COPYRIGHT STATEMENT

A portion of the disclosure of this patent application contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF THE INVENTION

The present invention relates to stepper motor drive systems in general and, in particular, to haptic interfaces using stepper motors.

### BACKGROUND OF THE INVENTION

Creating high performance haptic interfaces with force feedback capabilities creates unique challenges in mechanism and control design. To achieve crisp and responsive virtual surfaces needed for many haptic interface applications, smooth velocity measurements with negligible delay are desirable. The smoothness of the haptic interface is normally determined by the resolution of an encoder (also referred to as a sensor) used to measure movement of the input mechanism of the haptic interface, as well as the sampling rate of such sensors. Higher resolutions and sampling rates generally allow for smoother velocity estimates. Delay is typically determined by the speed of a central processor which calculates the velocity of such movements. For robust structural dynamics, there may be certain advantages to co-locating the encoder with the motor or actuator which delivers force feedback to the input mechanism.

Optical encoders are commonly used as position sensors in haptic interfaces because they are linear and rugged. While position sensing is achievable with current encoder technology, calculating velocity from the sensed positions may lead to inaccurate velocity estimates. Merely by way of example, if the resolution of the encoder is Δ radians, and the maximum sampling rate of the encoder is once every T seconds, then computing the velocity using a finite difference yields a velocity estimating resolution of Δ/T radians per second. Thus, a higher resolution encoder (i.e., one having a smaller Δ), and a slower sampling rate (i.e., one having a larger T), may lead to a higher, and therefore smoother, resolution velocity estimate. With a higher sampling rate, the velocity estimate can be filtered to improve the smoothness of the velocity data.

In certain instances, it is desirable for high performance haptic interfaces to be able to render forces and torques smoothly. The user may misinterpret a virtual environment (e.g., in a scientific visualization application, a simulated surgery, or a virtual game setting) if “edges” in the force rendering are noticeable (e.g., the force feedback motor starting and stopping). Here, it maybe useful to consider different ranges of velocities and forces/torques individually. When the haptic interface is manipulated at high velocities (e.g., 1 m/s), it is unlikely that the user is carefully probing the virtual environment, therefore smoothness may be less of a concern. Conversely, when the user is carefully exploring the virtual environment, velocities are likely to be low, and smoothness of force/torque rendering may be more important. Similarly, users may be less sensitive to small jumps in the forces/torques when high forces/torques are rendered than when low forces/torques are rendered.

Haptic interfaces have uses in a number of applications, ranging from force-feedback teleoperation systems to scientific data visualization to virtual training systems. Due to the variety of applications, haptic interface designs span a wide range, from interfaces with non-dexterous, power grips to many recent haptic interface designs with more sensitive and dexterous finger grips. A technical difficulty in many of these designs is providing accurate, high frequency force information to the user, in multiple degrees of freedom, and with large range of motion. This poses challenges in mechanism and control design. To achieve hard “crisp” surfaces, it may be desirable to have smooth velocity measurements with small computational delay. This is often provided via position sensing, resulting in requirements for position sensor resolution that far exceeds what users may kinsthetically distinguish. High bandwidth force transmission to the fingers generally calls for a lightweight, stiff transmission, and a low mass actuator with high force capability and low friction and ripple forces.

Certain embodiments of the invention, therefore, comprise motors that provide smooth, high bandwidth forces and torques, coupled with encoders that provide high resolution position and velocity measurements through various processing techniques.

### BRIEF SUMMARY OF THE INVENTION

In one exemplary embodiment of the invention, a method of producing a smoother torque from a multi-pole motor is described. An angular position of a rotor of the multi-pole motor is determined. A current is produced to drive the multi-pole motor, wherein the multi-pole motor is configured to produce a torque with substantially sinusoidal characteristics if it is driven by a steady current. The current is controlled based on the angular position of the rotor so as to produce a smoother torque, without the substantially sinusoidal characteristics of torque produced by a steady current. In another embodiment of the invention, an apparatus is described which employs methods of the invention to provide smoother torque from a multi-pole motor.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The present disclosure is described in conjunction with the appended figures:

FIG. 1A is a block diagram illustrating one embodiment of the invention for producing smoother torque from a multi-pole motor, according to various embodiments of the invention;

FIG. 1B is a block diagram illustrating an alternative embodiment of the invention for producing smoother torque from a multi-pole motor, according to various embodiments of the invention;

FIG. 2 is a block diagram illustrating an alternative embodiment of the invention for producing smoother torque from a multi-pole motor, according to various embodiments of the invention;

FIG. 3 is a simplified diagram of an apparatus which may be used to produce smoother torque from a multi-pole motor, according to various embodiments of the invention;

FIG. 4 is a graph illustrating a normalized motor torque versus mechanical shaft angle for a two winding, multi-pole motor;

FIG. 5 is a graph illustrating measure ripple forces from a multi-pole motor;

FIG. 6 is a graph illustrating an exemplary ripple torque delivered by a multi-pole motor which has had a ripple torque cancellation signal applied from the motor driver, according to various embodiments of the invention;

FIG. 7 is a block diagram illustrating one embodiment of the invention for producing smoother torque from a stepper motor where linking component characteristics, force sensing, and encoder ripple are accounted for by a multi-pole motor driver, according to various embodiments of the invention;

FIG. 8 is a block/flow diagram illustrating a haptic interface embodiment of the invention, according to various embodiments of the invention; and

FIG. 9A is a flow diagram illustrating one method of the invention for producing smoother torque from a multi-pole motor by determining an angular position of a rotor, producing current, and controlling the current, according to various embodiments of the invention;

FIG. 9B is a flow diagram illustrating another method of the invention for producing smoother torque from a multi-pole motor, similar to that shown in FIG. 9A, except showing one possible method of determining an angular position of the rotor which includes sensing the rotor position, producing an analog output representative of the position, and computing the angular position based on the analog output;

FIG. 9C is a flow diagram illustrating another method of the invention for producing smoother torque from a multi-pole motor, similar to that shown in FIG. 9B, except also including matching a period of an analog output with a period of the motor;

FIG. 9D is a flow diagram illustrating another method of the invention for producing smoother torque from a multi-pole motor, similar to that shown in FIG. 9C, except also including receiving an input;

FIG. 9E is a flow diagram illustrating another method of the invention for producing smoother torque from a multi-pole motor, similar to that shown in FIG. 9D, except also including determining a ripple torque associated with the motor and applying a ripple torque cancellation signal;

FIG. 9F is a flow diagram illustrating another method of the invention for producing smoother torque from a multi-pole motor, similar to that shown in FIG. 9E, except showing one possible method of determining the ripple torque which includes measuring torque at a plurality of positions, modeling the ripple torque, and determining the ripple torque at the angular position of the rotor;

FIG. 9G is a flow diagram illustrating another method of the invention for producing smoother torque from a multi-pole motor, similar to that shown in FIG. 9F, except also including determining an encoder ripple;

FIG. 9H is a flow diagram illustrating another method of the invention for producing smoother torque from a multi-pole motor, similar to that shown in FIG. 9G, except showing one possible method of determining an encoder ripple which includes measuring a plurality of encoder positions and calculating an estimate of the true angular position of the rotor;

FIG. 9I is a flow diagram illustrating another method of the invention for producing smoother torque from a multi-pole motor, similar to that shown in FIG. 9H, except also including determining mechanical characteristics of a linking component; and

FIG. 9J is a flow diagram illustrating another method of the invention for producing smoother torque from a multi-pole motor, similar to that shown in FIG. 9I, except also including determining a force; and

FIG. 10 is a generalized schematic drawing illustrating a computer system that may be used in accordance with various embodiments of the invention.

### DETAILED DESCRIPTION OF THE INVENTION

This description provides exemplary embodiments only, and is not intended to limit the scope, applicability or configuration of the invention. Rather, the ensuing description of the embodiments will provide those skilled in the art with an enabling description for implementing embodiments of the invention. Various changes may be made in the function and arrangement of elements without departing from the spirit and scope of the invention as set forth in the appended claims.

Thus, various embodiments may omit, substitute, or add various procedures or components as appropriate. For instance, it should be appreciated that in alternative embodiments, the methods may be performed in an order different than that described, and that various steps may be added, omitted or combined. Also, features described with respect to certain embodiments may be combined in various other embodiments. Different aspects and elements of the embodiments may be combined in a similar manner.

It should also be appreciated that the following systems, methods, and software may be a component of a larger system, wherein other procedures may take precedence over or otherwise modify their application. Also, a number of steps may be required before, after, or concurrently with the following embodiments.

I. Overview: In one exemplary embodiment of the invention, a method for producing a smoother torque from a multi-pole motor is described. The multi-pole motor may, for example, be a stepper motor. The method includes determining an angular position of a rotor of the multi-pole motor. A current to drive the multi-pole motor is produced, wherein the multi-pole motor is configured to produce a torque with substantially sinusoidal characteristics if it is driven by a steady current. The current is controlled based on the angular position of the rotor so as to produce a smoother torque without the substantially sinusoidal characteristics of torque produced by a steady current.

In some embodiments, the determination of the angular position of the rotor may include the following steps: sensing a rotor position of the multi-pole motor, producing an analog output representative of the sensed rotor position, and computing the angular rotation based at least in part on the analog output. The analog output may include a first sinusoidal voltage and a second sinusoidal voltage, in quadrature, where each sinusoidal voltage represents a different sensed rotor position of the multi-pole motor. In some embodiments, the method may further include matching a period of this analog output with an electrical period of the multi-pole motor. Changes in rotor position may be caused by a received input at an input device coupled with the multi-pole motor. The current to drive the multi-pole motor may be controlled to produce a force at the input device responsive to the received input.

In some embodiments of the invention, a ripple torque associated with the multi-pole motor may be determined. In these embodiments, a ripple torque cancellation signal is applied to vary the current and thereby substantially cancel the determined ripple torque. Determining the ripple torque is accomplished in some embodiments by measuring the torque necessary to hold each of a plurality of positions of the multi-pole motor. The plurality of torque measurements may be modeled as an affine or other function of the measured torque. The torque ripple associated with an angular position can then be determined based on the modeled ripple torque.

Ripple torque associated with the multi-pole motor may be caused by any number of factors, including, but not limited to: non-optimized tooth profile in a stator of the multi-pole motor; non-optimized tooth profile in the rotor of the multi-pole motor; variation between tooth profiles in the stator of the multi-pole motor; variation between tooth profiles in the rotor of the multi-pole motor; and/or errors in the angular position determination.

In some embodiments, a method of producing smoother torques from a multi-pole motor may also include unwarping encoder ripple. An encoder ripple associated with a determination of an angular position may be computed. The current driving the multi-pole motor is varied to unwarp the encoder ripple. A plurality of encoder positions may be measured over an encoder period while the multi-pole motor is at a substantially constant velocity, the measure taken while the multi-pole motor is off-line. An estimate of a true angular position is calculated based on the measured plurality of encoder positions during real-time operation.

Encoder ripple may be caused by any one or more of the following: variations between the optical reflectance of an encoder disk used to determine angular position; variations between the electrical properties of an optical sensor used to determine angular position; variations between the magnetic properties of a Hall sensor used to determine angular position; variations between the electrical properties of a Hall sensor used to determine angular position; eccentricity in mounting an encoder disk used to determine angular position; eccentricity in mounting a Hall sensor component used to determine angular position; the planarity of the encoder disk being different than the planarity of the sensor used to determine angular position; the plane of the encoder disk not being perfectly perpendicular to the shaft of the multi-pole motor; and physical manufacturing defects in the encoder disk.

In some applications, such as haptic devices and other force-feedback systems, the method may further include determining the mechanical characteristics of a linking component coupling an input device to the multi-pole motor. The current produced to drive the multi-pole motor may be varied based at least in part on the determined mechanical characteristics of the linking component. One possible mechanical characteristic of the linking component may be a spring coefficient.

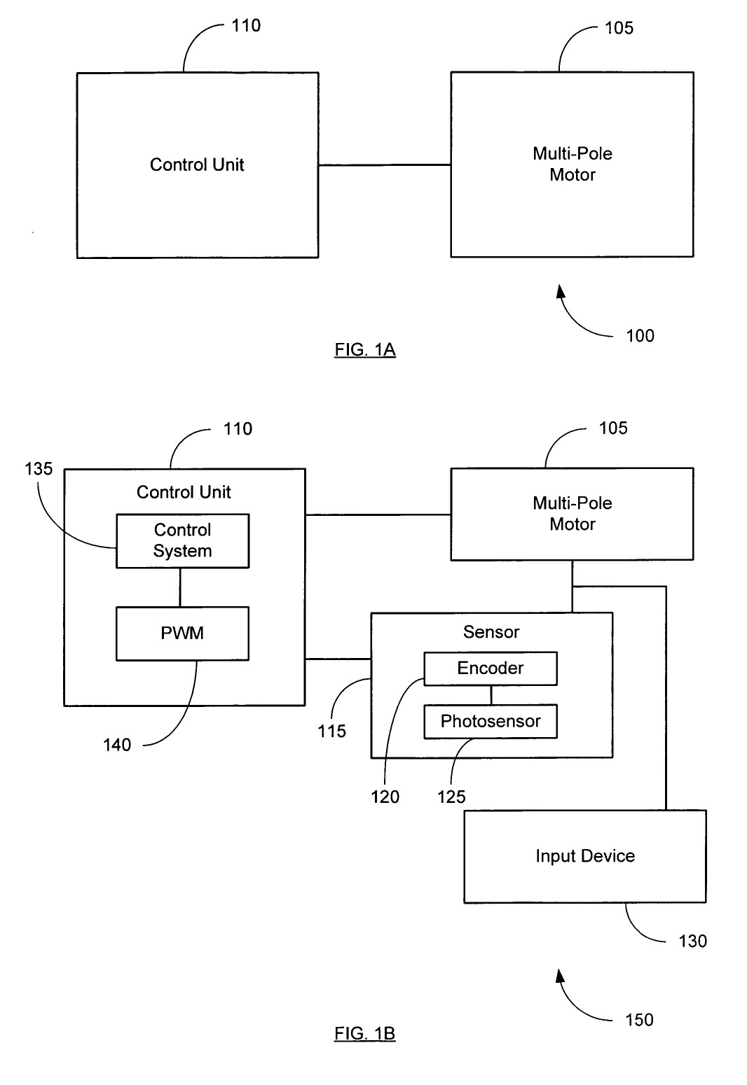

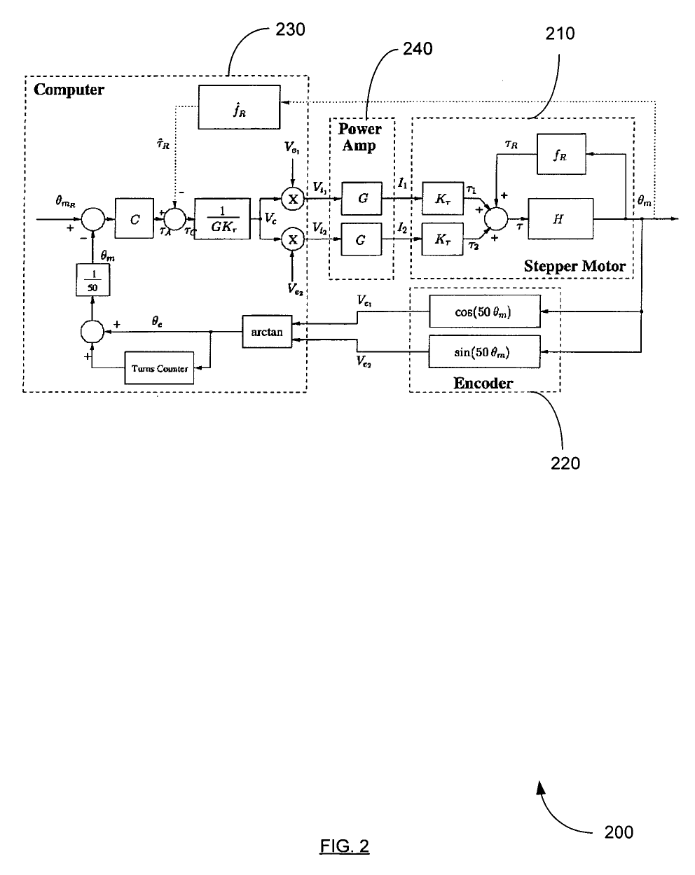

In another exemplary embodiment of the invention, an apparatus for producing a smoother torque from a multi-pole motor is illustrated. As shown in FIG. 1A, the exemplary apparatus 100 includes a multi-pole motor 105 configured to produce a torque with substantially sinusoidal characteristics when driven by a steady current. The apparatus 100 also includes a control unit 110 coupled with the multi-pole motor 105. The control unit 110 is configured to determine an angular position of a rotor of the multi-pole motor 105, produce a current to drive the multi-pole motor 105, and control the current based on the determined angular position to thereby produce a smoother torque without the substantially sinusoidal characteristics. The multi-pole motor 105 may be a stepper motor.

The apparatus 100 may contain one or more additional multi-pole motors. In these, or other embodiments, the apparatus may include a user interface coupled with each of the multi-pole motors. The control unit may produce a current to drive each of the one or more additional multi-pole motors. The multi-pole motors may be coupled with the user interface.

As shown in FIG. 1B, an apparatus 150 comprising an alternative exemplary embodiment is illustrated. The apparatus 150 may also have a sensor 115 to identify a rotor position of the multi-pole motor 105, and a circuit to produce an analog output representative of the identified rotor position. The control unit 110 may determine the angular position by computing the angular position based at least in part on the analog output. The sensor may be an optical encoder 120, where such an optical encoder 120 may include a reflective disk with a plurality of lines and at least one photosensor 125 configured to signal a change in position by reading the reflective disk as it spins.

In embodiments having a sensor 115, or other embodiments, there may be an input device 130 coupled with the multi-pole motor 105 and configured to receive input which causes a change in the rotor position. A control unit 110 in such embodiments may further control the current to drive the multi-pole motor 105 to produce a force at the input device 130 responsive to the received input. The input device 130 may be a haptic interface.

The control unit 110 in some embodiments may include a control system 135 and a pulse width modulation (PWM) driver 140 coupled with the control system. The PWM driver 140 may be configured to produce the current by controlling a switching frequency. In these and other embodiments, the control unit 110 may also be configured to determine a ripple torque associated with the multi-pole motor 105. The control unit 110 may apply a ripple torque cancellation signal to vary the current and thereby substantially cancel the determined ripple torque.

In these and other embodiments, the control unit 110 may also be configured to measure a torque necessary to hold each of a plurality of positions of the multi-pole motor 105. The control unit 110 may model ripple torque as an affine or other function of the measured torque, wherein the control unit 110 determines the ripple torque at the angular position possibly based on the modeled ripple torque. The control unit 110 may be configured, in some embodiments, to determine an encoder ripple associated with the determination of the angular position and vary the current to unwarp the determined encoder ripple. The control unit 110 may be configured to measure a plurality of encoder positions over an encoder period while the multi-pole motor is at a substantially constant velocity while the multi-pole motor is off-line. The control unit 110 may determine encoder ripple by calculating an estimate of a true angular position based on the measured plurality of encoder positions during real-time operation. While in the above embodiments, certain specified components are used to carry out the functions of the apparatus, in other embodiments, different means may be used, as well.

II. Motor and Encoder: The invention will now be discussed in greater detail with reference to exemplary embodiments. FIG. 2 is a block diagram of an exemplary embodiment of the invention comprising an apparatus 200 including a stepper motor 210, an encoder 220 to electrically commutate the stepper motor, a computer 230, and a PWM power amplifier 240, producing high torque levels with low ripple. The motor 210 is shown connected with the encoder 220 to provide angular position data. A computer 230 interprets the various data received by embodiments of the invention and directs the PWM 240 to deliver current to the motor 210. The computer 230 may comprise the control unit 110, or the control system 135, discussed above. The interrelation of these different components is described in detail below.

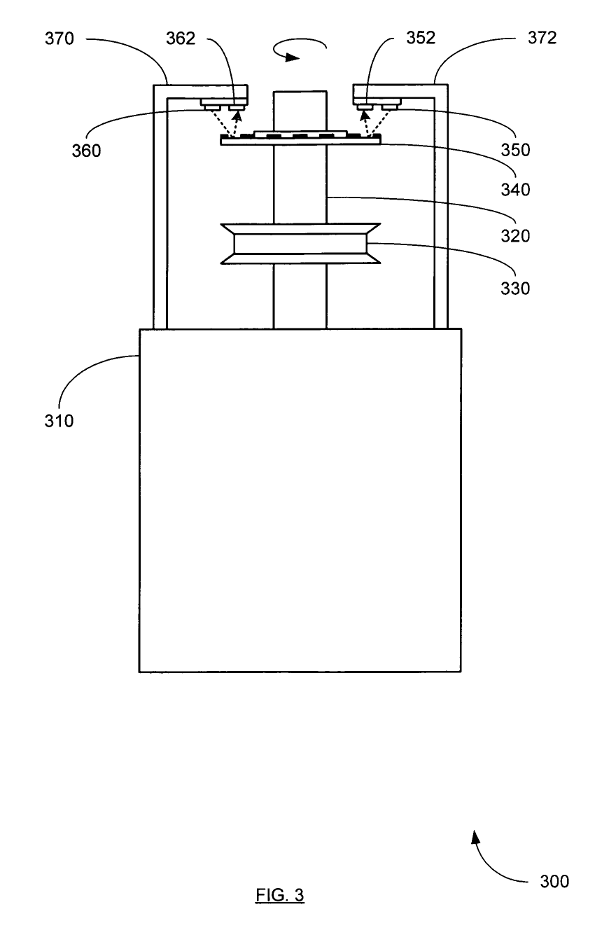

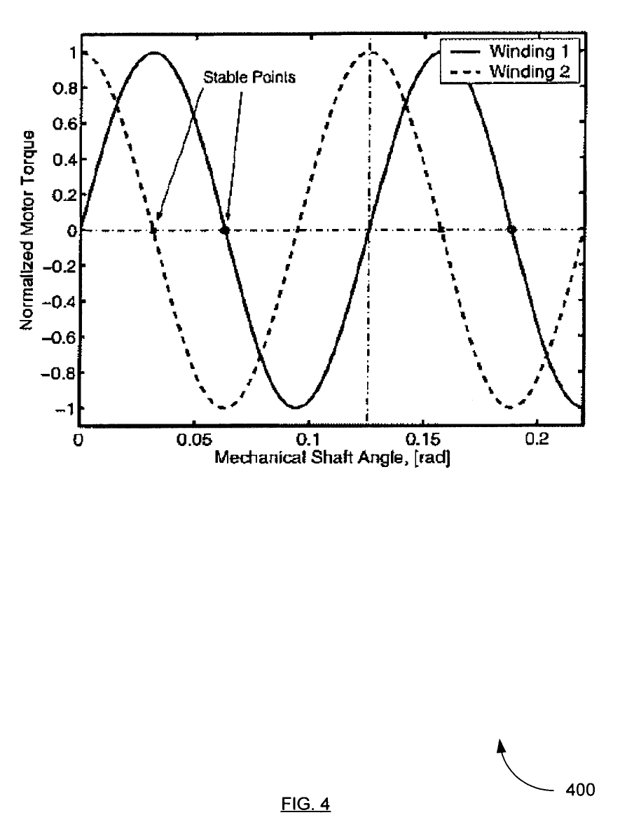

FIG. 3 is a simplified diagram 300 of an exemplary apparatus which may be used to produce smoother torque from a multi-pole motor. A multi-pole motor 310 is shown having a shaft 320 attached to the rotor of the motor 310. Attached to the shaft 310 is a pulley 330 which may be used to link the motor to an input device, possibly in a haptic system. An encoder wheel 340, with alternating reflective and non reflective surfaces, is shown attached to the shaft 320. Optical emitters 350, 360 emit light or other suitable transmissions, which reflect off the encoder wheel 340 and are received by optical sensors 352, 362. Each optical emitter 350, 360 and its associated optical sensor 352, 362 may make up an individual sensor package. Supports 370, 372 mount the sensor packages so that they are stationary with respect to the shaft 320. Information from the sensor packages may be transmitted to an associated system and processed so as to vary the current delivered to the motor 310 as discussed herein.

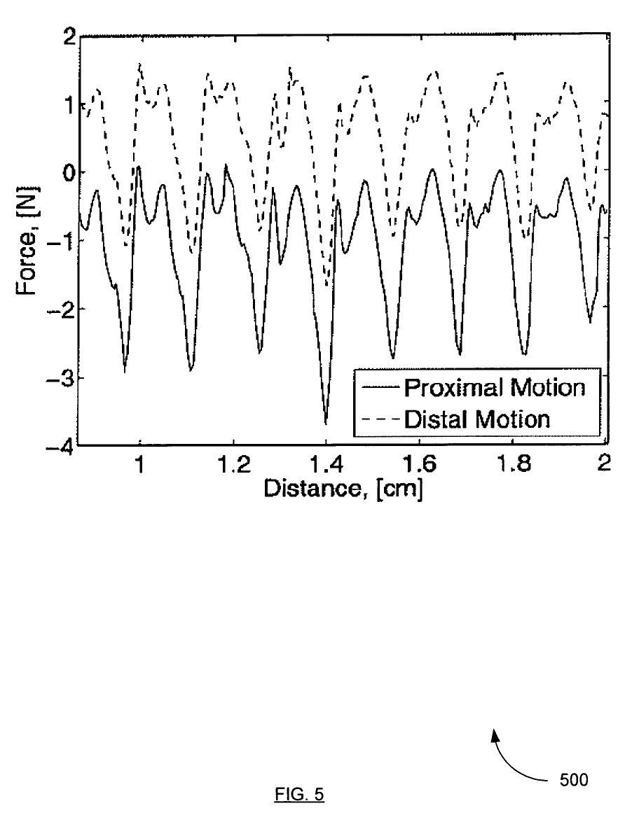

In an exemplary embodiment, the multi-pole motor may be a 50 pole stepper motor that has a step size of 1.8° (4 steps per pole and 50 poles per mechanical turn), though other stepper motors with different configurations could also be driven by various other embodiments of the invention. Torque produced by such a stepper motor is approximately a sinusoidal function of mechanical rotor-stator angular position θₘ at constant coil current Iₒ, and this torque is approximately periodic on each electrical turn Tₑ, where Tₑ=7.2° or 0.1258 radians. In this embodiment, there are 50 electrical turns per mechanical turn Tₘ=360°. Note that the two coils in the exemplary stepper motor produce torque in quadrature (i.e., with a 90° phase shift). FIG. 4 is a graph 400 of normalized motor torque versus mechanical shaft angle for a nominal two winding, multi-pole motor. The normalized motor torque is indicative of the torque delivered by such a nominal motor in response to a steady current. Methods of the present invention may remove the sinusoidal characteristic of this torque by applying a sinusoidal torque to each of the windings to “cancel” such torque. In some embodiments, this is achieved by the PWM 140, which works by comparing a current command from the user to the actual motor current, and uses this error to appropriately modulate the pulse widths of the driver output (and thereby control the current flow).

The total torque τ developed in the motor is the sum of the torques produced by each coil:
τ=τ₁+τ₂≈K_{τ}I₁ sin(θₑ)+K_{τ}I₂ cos(θₑ)
where K_{τ} is the motor torque constant and θₑ is the electrical angle which goes through 2π radians on each electrical turn Tₑ. This sinusoidal relationship is approximate, because the teeth of the rotor and stator poles may not be optimized for sinusoidal torque. Slight differences away from pure sinusoidal torque may occur on each electrical turn, and these torques may differ slightly across the 50 electrical turns due to imprecise tooth shapes in the stamped motor laminations which result from manufacturing processes. Furthermore, variation in the reluctance of the flux paths with rotation angle produces additional cogging torque. Thus, the actual torque produced by the motor consists of the sinusoidal components above, plus a ripple torque τ_{R} which is generally a function of both rotor-stator angle and coil current:
τ_{R}=f₁(I₁,θₘ)+f₂(I₂,θₘ)=f(I₁,I₂,θₘ).

Assuming that the torques provided by the motor are sinusoidal and have no ripple torque (i.e., τ_{R}=0), then prescribing current in the coils that is also a sinusoidal function of electrical angle produces smooth commanded torque τ_{C}:

$${I}_{C} = \frac{1}{{K}_{r}} {τ}_{C}$$

$${I}_{1} = {I}_{C} sin ( {θ}_{e} ) ; {I}_{2} = {I}_{C} cos ( {θ}_{e} ) ,$$

and results in:
τ=K_{τ}I_{C}(sin² (θₑ)+cos² (θₑ))=K_{τ}I_{C}=τ_{C}.
Applying sinusoidal current in this manner to a stepper motor may be termed sine wave commutation, and may be used to ensure adequate and accurate torque production.

However, for improved sine wave commutation, the angular position of the rotor should be known to a smaller fraction of an electrical turn in order for the resulting motor current to be a smooth sinusoid. Furthermore, it may be desirable to cancel the ripple torques τ_{R}, which are the differences between the actual torques and the assumed sinusoidal torques. In some embodiments, to determine ripple torque, an additional feedback torque is provided that is also a function of rotor position. To provide small enough residual torque ripple, embodiments of the invention estimate these disturbance torques, which may have significant Fourier components at several times the electrical turn frequency. First consider, for example, a position sensor with a resolution of 1 part in 8,000 in 1 mechanical turn may provide a rotor position sensing resolution of 180 points per electrical turn, which will provide at least 32 measurement points per harmonic cycle up to the 5th harmonic in the disturbance torques. Alternatively, an optical encoder with 2000 lines per turn or more may provide this resolution with quadrature decoding (quadrature decoding multiplies resolution by 4).

But by instead choosing the optical and electrical parameters of the decoder and associated sensor appropriately, it is possible to produce a pair of quadrature voltages that are approximately sinusoidal functions of rotor position, periodic on the angular spacing of the optical stripes on the encoder disk. Quadrature phasing of the two optical sensors may be provided by locating the two optical sensors at an appropriate spacing around the circumference of the encoder disk. The angular position of the rotor within one optical period may then be computed by taking the arc-tangent of the two quadrature signals. Total angle may be computed by accumulating the changes of this optical angle.

While many different optical periods may be used, in some embodiments, the optical and electrical periods may be matched so that the encoder signals have the same period as the motor torques. This way, the position within an electrical turn may be known with fewer issues of initialization or slip that occur with incremental measurements. With the motor discussed above, a 50 line optical encoder disk may thus be employed. Moreover, if the optical encoder is aligned with the motor torque phasing so that the normalized encoder voltages are given by:
Vₑ₁≈sin(θₑ); Vₑ₁≈cos(θₑ),
then an inverse tangent may not be needed for commutation, and current may be set to:
I₁=IₒVₑ₁; I₂=IₒVₑ₂
to achieve the sine wave commutation. Such an alignment may be done during assembly of an embodiment by applying a fixed voltage to one motor winding, and causing the motor to hold at a particular angular position within the electrical turn (this may be the normal “hold” mode of a stepper motor at a stable point). The optical encoder disk may then be rotated on the motor shaft to produce the correct phasing of Vₑ₁ and Vₑ₂ relative to τ₁ and τ₂, and then clamped in place on the shaft.

By way of example, position sensing resolution of 1 part in 1000 on an electrical turn yields angular position sensing resolution of 1 part in 50,000 on one mechanical turn. With a direct drive pulley radius of 11.4 mm, this produces a prismatic actuator with sensing resolution of 1.4 μm which, as discussed above, may be in the range preferred in haptic interface applications where virtual surfaces are rendered. One part in 50 accuracy per electrical turn provides a prismatic position sensing accuracy of 26 μm, below human sensing capability. This encoding scheme provides smooth, high resolution sensing to avoid transients in the rendered forces, which may be highly perceptible.

III. Electronics and Signal Processing: To drive a multi-pole motor in the manner described above, there are a number of issues that may be considered in the configuration of the control unit 110 and multi-pole motor 105. One possible stepper motor that may be controlled in exemplary embodiments of the invention has a torque constant K_{τ}=0.17 Nm/A, resulting in high torque and correspondingly high back EMF (K_{EMF}=0.17 V/rad/sec). Closer angular pole spacing found in stepper motors may produce larger magnetic field gradients for a given number of ampere-turns in the windings. Larger effective torque constants may also be obtained by using a gear head in a conventional motor to magnify torque. At a given output shaft speed, the resulting larger motor speed also produces a larger back EMF voltage. The stepper motor avoids the friction, backlash, and inertia effects of a gear head by utilizing “electromagnetic gearing.” Higher voltages may need to be provided by the motor driver to overcome the larger back EMF found in stepper motors.

A secondary effect of the greater number of motor poles found in a stepper motor is the increased demand on driver bandwidth (e.g., from the PWM power amp 140, 240). At a given mechanical shaft speed, the sine wave driver may provide currents that are sinusoidal functions of time at frequencies that are, in this case, 50 times that of the shaft rotation frequency. It may be desired to have a prismatic actuator with a 1 m/s maximum speed, which is compatible with human voluntary hand motion with a desktop haptic interface. With a pulley of radius 11.4 mm, a stepper motor shaft speed of ω=87 red/sec may be desired, and the sine wave driver may provide full-scale coil currents at 4350 radians/second or 690 Hz. Driver bandwidth below 1 kHz could result in reduced amplitude and imperfect phase shifted delivered current, resulting in degraded torque.

Motor winding inductance may necessitate that the driver voltage increase with commutation frequency to supply the desired current. If the voltage rails in the driver are too small, the current becomes slew-rate limited at high frequencies and high amplitudes, becoming another cause of reduced current and imperfect commutation.

By way of example, maximum prismatic actuator force of 10 N at a maximum speed of 1 m/s may be desired in some systems. In the present example, this results in full scale torques of τₘ=0.11 Nm to be supplied up to a shaft speed of ωₘ=87 rad/sec, or an electrical turn frequency of 4350 radians/second. With an armature resistance R of 8Ω and an inductance L in each motor coil of 10 mH, this implies that a driver capable of supplying 48 V at 0.65 A is needed:
Iₘ=τₘ/Kᵣ=0.65 A
Vₘ=K_{EMfwm}+IₘR+Iₘ(50)ωhd mL
=15+5+28=48 V.
As will now be apparent to those skilled in the art, the inductive impedance term dominates both the resistive impedance and back EMF terms in this voltage, due mostly to the large number of motor poles in the present example (factor of 50). Thus, the driver, in some embodiments, may be a transconductance type, i.e., with an internal current feedback loop to move the R/L corner frequency (127 Hz in this case) out to the required bandwidth, though other drivers are possible within the scope of the invention. The large signal band-width of this loop will be above 1 kHz to have a low torque loss due to amplitude and phase loss in the desired motor current in many embodiments.

In one embodiment, a PWM power amplifier 140 may be configured as follows. Modern MOSFET switches dissipate little power when ‘on’ due to resistances on the order of 0.03Ω. By controlling the average on-time of these switches, the average current over a switch cycle can be accurately controlled, with little dissipation in the driver. The driver dissipation is driven by the PWM switching frequency, since significant instantaneous power is dissipated over tens of nanoseconds as the drivers pass from the fully off to the fully on state, and as “shoot through” currents occur due to reverse recovery in “free-wheeling” diodes. An exemplary PWM driver may deliver a full scale current of ±0.65 A at any voltage up to ±60 V with approximately 2 W total dissipation. These embodiments may not require a heat sink. Such an exemplary PWM may switch at 100 kHz, and have a small signal current loop bandwidth of 30 kHz, and a slew rate of 6000 A/sec into a 10 mH inductive load. Full scale sinusoidal current bandwidth may be 2 kHz.

The sampling frequency of the commutation computer (e.g., which may comprise the control unit 110) may be fast relative to the commutation frequency. If 250 samples per commutation cycle at the maximum shaft speed of 87 radians/second is desired, a sample rate of (250)(50)(87)/(27π)=173 kHz results. This can be relaxed since accurate torque ripple cancellation may not be required at top speed in most haptic interface applications, as noted above. It may be desirable, however, to sample fast enough at high rotation speeds so that significant delays are not introduced into the commutation cycle. Reasonable phase loss (about 7 deg) is obtained at 25 samples per commutation cycle at 87 rad/sec, resulting in a sampling rate of 17 kHz in the commutation computer. This is faster than the loop rates in most haptic rendering applications and, since it involves very simple computations, it may be preferably suited to DSP implementation.

IV. Torque Ripple Cancellation: Departure from pure sinusoidal torque profiles in the commutation cycle of multi-pole motors may result in unwanted ripple or cogging torque, τ_{R}. These torques may be caused by tooth profiles in the stator and rotor not being optimized for sinusoidal torque, by variation from tooth to tooth in both the stator and rotor due to manufacturing tolerances, and/or by errors in the angular position measurement within the commutation cycle due to imperfect sinusoidal encoder signals.

Presently disclosed is a self-calibration technique that uses a control loop to measure the ripple torque, which may be used in a feedback torque cancellation scheme. In other embodiments, different methods of measuring a ripple torque may be applied, as known in the art. Due to the slight variations from pole to pole, however, this approach may be more accurate when the electrical turns can be distinguished. Since the encoder may only provide positioning within an electrical turn, the electrical turn count within a mechanical turn may be initialized at a known count, and maintained incrementally thereafter. This may be provided by a mechanical stop at one extreme of the range of motion.

In one approach, a position control loop may be closed around the motor, which accurately holds the motor in a series of fixed mechanical reference positions θ_{mR}. The torque τ_{C} necessary to hold each position is computed by a control loop (i.e., the torque is automatically adjusted until the position error goes to zero). This torque consists of the unwanted ripple torque τ_{R} and the external load torque τ_{L}, since the net torque τ on the motor inertia:
τ=τ_{C}−τ_{L}+τ_{R}
is substantially zero when the settled position θₘ is constant. That is, the measured torque τ_{CS} at each settled position θₘ≈θ_{mR} is
τ_{CS}=τ_{L}+τ_{R}.
Note that in such a scheme, the external load torque τ_{L} should be known in order to measure τ_{R}. This may be accomplished by loading the motor with a constant load (e.g., a hanging weight), or a spring whose smooth torque variation with angle can be subtracted out of the τ_{CS} data.

Also note that since, in this embodiment, the coil currents are specific functions of angle and commanded torque, the ripple torque is also a function ƒ_{R}(τ_{C}, θₘ) of commanded torque and mechanical angle. Since the stepper used in this embodiment may be a hybrid type, which contains a permanent magnet, the magnetic flux in the motor is non-zero at zero commanded torque. That is, there is cogging torque with no current applied, as well as deviation from pure sinusoidal torque when current is applied. A model of this situation parameterizes ripple torque as an affine or other function of τ_{C}:
τ_{R}=ƒ_{R}(τ_{C}, θₘ)=τ_{C}ƒ_{C}(θₘ)+ƒ_{M}(θₘ).
Identifying the functions ƒ_{C} and ƒ_{M} enables \hat{ƒ}_{R} to be created for any angle θₘ and any commanded torque r_{C}. This function is then stored in the commutation computer (e.g., the control unit 110) and interpolated during motor operation to yield an estimate of the ripple torque at any angular position. Subtracting this estimate from subsequent motor commands then approximately cancels the ripple torque. If the calibration process is repeated again with the cancellation in place, the torque τ_{A} required to hold position is a measure of the residual from the cancellation (i.e., a quantitative measure of the accuracy of the cancellation scheme).

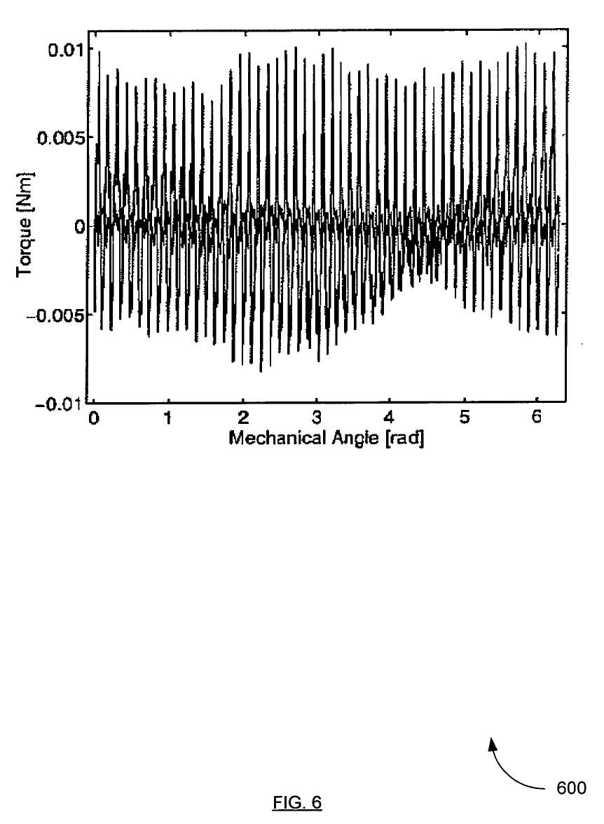

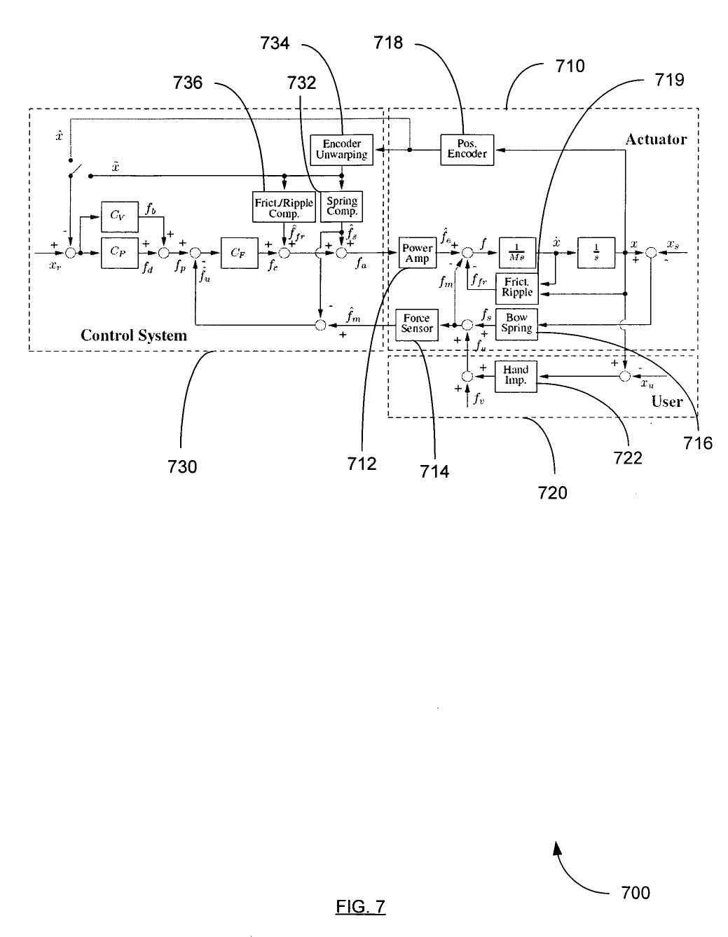

FIG. 5 is a graph 500 of measure ripple forces derived from the torque of a multi-pole motor actuated in two directions. After determining these ripple forces/torques using the methods of the invention, they may be cancelled out as described above, or using other methods as appreciated by one skilled in the art. Note that the “factory calibration” described above to determine the ripple torques may be performed only once for a given stepper motor in some embodiments. Those skilled in the art will recognize that the process could be highly automated. FIG. 6 is a graph 600 showing the minimal levels of measured ripple torque after such a cancellation scheme is implemented on an exemplary motor. Comparing FIG. 6 to FIG. 5, it will now be apparent to those skilled in the art that the torque ripple cancellation method described above has reduced torque ripple to below 0.01 Newton-Meters in the embodiments described.

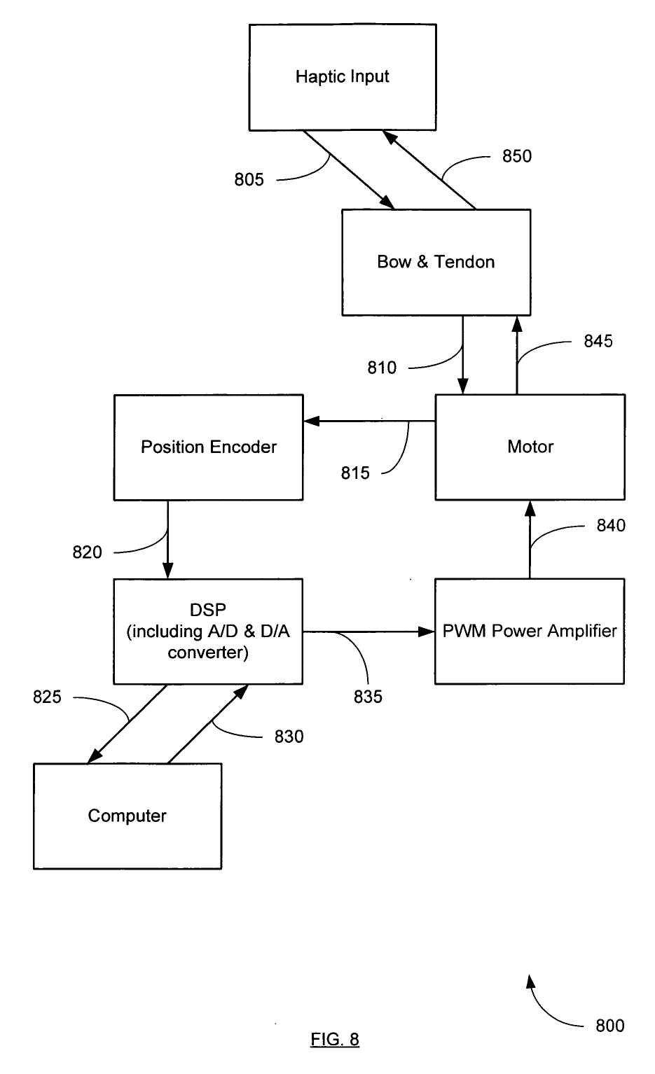

V. Input Compensation Embodiments: This section discusses several types of compensation schemes that may be employed by the control system to ameliorate residual torque/force defects which affect multi-pole motors in haptic or other systems employing input devices. FIG. 7 is a block diagram 700 illustrating various input compensation schemes according to one embodiment of the invention. As will be illustrated, linking component characteristics, force sensing, encoder ripple, and system friction compensation may be accounted for by employing these control schemes. FIG. 7 shows an actuator 710 which may deliver force when driven by a power amplifier 712, while also able to receive forces at a force sensor 714 when said forces are delivered by a user 720 through a hand input movements 722. The force sensor 714 may then deliver data back to the control system 730.

The user input device is connected to the actuator 710 by a bow spring 716 in this embodiment, though other linking components may be used in other embodiments. A position encoder 718 is present in the actuator, and may deliver position information back to the control system 730. Various possible control methods are discussed in the following subsections.

A. Linking Components: In some embodiments, the control unit and multi-pole motor may be used in a haptic interface. In such embodiments, an input device may be connected to the multi-pole motor with a linking component. In exemplary embodiments a bow spring 716 and mechanical tendon may be the linking component. The bow spring 716 may provide the bias force necessary to achieve bidirectional actuation forces by varying tension in the tendon around the bias force. A prediction of the proper bias force may be determined so that the motor can counteract and balance the spring force, preventing the user from feeling these bias forces as the input device is moved throughout its range of motion. In these embodiments, the control system calculates the bow spring 716 deflection force ƒₛ at each time sample k as an affine or other function of instantaneous position x. Ideally, the user feels only the difference between this force and the applied actuator force ƒₐ.

Data for such a model may be obtained in a self-calibration process, where a position control loop is used to place the multi-pole motor at a series of positions, measuring the forces ƒₐ necessary to hold these positions. When this model is applied, and linking component characteristics are accounted for by a subroutine 732 of the control system 730, the spring forces felt by a user will be minimized and, when the input device is released, the input device may remain at the same position.

B. Force Feedback Response: In many haptic interface applications, a responsive force to a user input may not occur until a sufficient motion occurs, but it may be desirable to respond to forces that produce such movements before the movements are actually caused. Since the force a user applies to such an interface or input is usually unpredictable, such input forces are preferably measured near the point where the input device is located. Once the input forces are measured, possibly by a force sensor 714 near the user input, the control unit may respond by controlling the current to the multi-pole motor which is coupled with the user input device.

C. Encoder Ripple: Variations in optical reflectance and eccentricity in mounting an optical encoder 718 may occur in some embodiments, possibly because of imprecise manufacturing and alignment techniques. This may result in a non-circular and variable (warped) relationship between the quadrature signals of two sensors used in some embodiments, leading to inaccurate position measurement. In embodiments using a Hall sensor, variations in the magnetic or electric properties of the Hall sensor, as well as mounting eccentricity, may also cause encoder ripple.

In some embodiments, the multi-pole motor may be made to move, during a calibration cycle, while off-line, at an approximately constant velocity over an encoder period. An accurate estimate of the motor position versus time may be determined by fitting a constant velocity \overline{x} function to the measured \hat{x} data. Taking \hat{x}(tᵢ) data from a calibration cycle, the data may be fit with a 6th-order or other low order polynomial approximant \overline{x}(tᵢ) over one mechanical turn. Interpolating this function at times tᵢ provides a \overline{x}(tᵢ) corresponding to every value of \hat{x}(tᵢ) measured. The function Δx(tᵢ)=\hat{x}(tᵢ)−\overline{x}(tᵢ)=h(\hat{x}(tᵢ)) may then be fit with a cubic or other low-order spline, using 500 control points tᵢ per mechanical turn (10 control points per encoder period), with 10 points of additional data before and after the one-turn interval to reduce fitting errors on the one-turn boundary. The spline fit approximates the h(\hat{x}) data by a smooth function:
\tilde{h}(\hat{x})=AΔxⱼ+BΔxⱼ₊₁+CΔx″ⱼ+DΔx″ⱼ₊₁
where the ″ indicates second-derivative estimates from sampled data, and the interpolation coefficients are given by:

$$A ≡ \frac{{\hat{x}}_{j + 1} - \hat{x}}{{\hat{x}}_{j + 1} - {\hat{x}}_{j}} , B ≡ 1 - A = \frac{\hat{x} - {\hat{x}}_{j}}{{\hat{x}}_{j + 1} - {\hat{x}}_{j}} \\ C ≡ \frac{1}{6} ( {A}^{3} - A ) {( {\hat{x}}_{j + 1} - {\hat{x}}_{j} )}^{2} , \\ D ≡ \frac{1}{6} ( {B}^{3} - B ) {\hat{x}}_{j + 1} - {\hat{x}}_{j} {\text{)}}^{2} .$$

A real-time unwarping process 734 within the control system 730 may implement this by determining which interval [\hat{x}ⱼ, \hat{x}ⱼ₊₁] the measured data \hat{x} resides, and then computing the interpolation coefficients A, B, C, and D. The values of Δx″ⱼ and DΔx″ⱼ₊₁ may then be retrieved during real time operation from data stored, possibly in the control unit, during the calibration cycle. The interpolated value \tilde{x}=\hat{x}−\tilde{h}(\hat{x}) may then be used as the unwarped angular position estimate.

D. Friction Compensation: As in any mechanical system, a haptic interface or other user input interface linked to the actuator 710 and control system 730 may have undesirable frictional characteristics. These forces may be measured and compensated for by the control system 730. The control system 730 may instruct the power amplifier 712 to deliver a modified signal to the force delivery device, possible a multi-pole motor, which compensates for the frictional characteristics of the system, thereby making them imperceptible to the user 720. In FIG. 7, the block diagram shows friction 719 within the actuator 710. An estimate of the friction may be computed in the control system 730, and hence compensating for the friction in sub-process 736. The control system 730 may thereafter modify the signal sent to the power amplifier 712 so as to compensate for the frictional characteristics of the user input interface. This may result in the frictional characteristics being less perceptible to the user 720.

FIG. 8 is a block/flow diagram of illustrating a haptic interface embodiment of the invention. In the embodiment shown, a user may input a motion at a haptic input, which is transferred 805 through a bow and tendon linking component. The motion may then be transferred 810 to a rotor on a motor. The rotor may have a position encoder which measures 815 the motion. A digital signal processor may receive 820 a signal representing this motion and convert the information into data usable by a computer and transfer 825 the data thereto. The computer may determine a response and transmit 830 the desired force response back to the digital signal processor. The digital signal processor may then instruct 835 the pulse wave modulator to send 840 a current to the motor so as to generate a force responsive to the user input. The force may be transmitted 845 to the bow and tendon and, therefore, transmitted 850 to the haptic interface, causing the user to feel a response to the inputted movement of the input device.

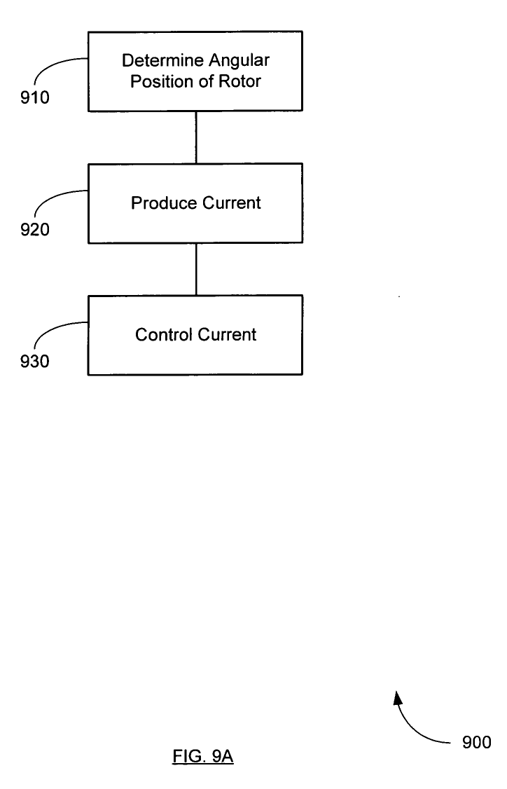

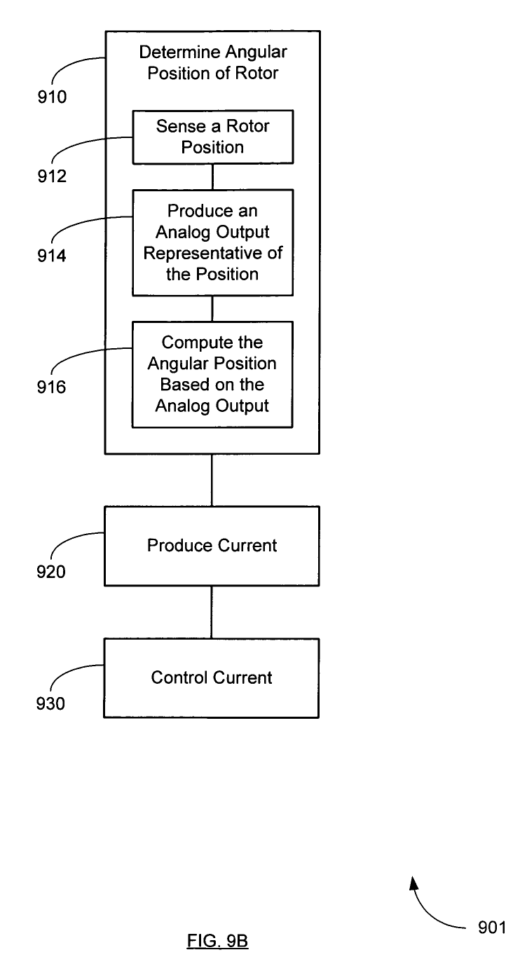

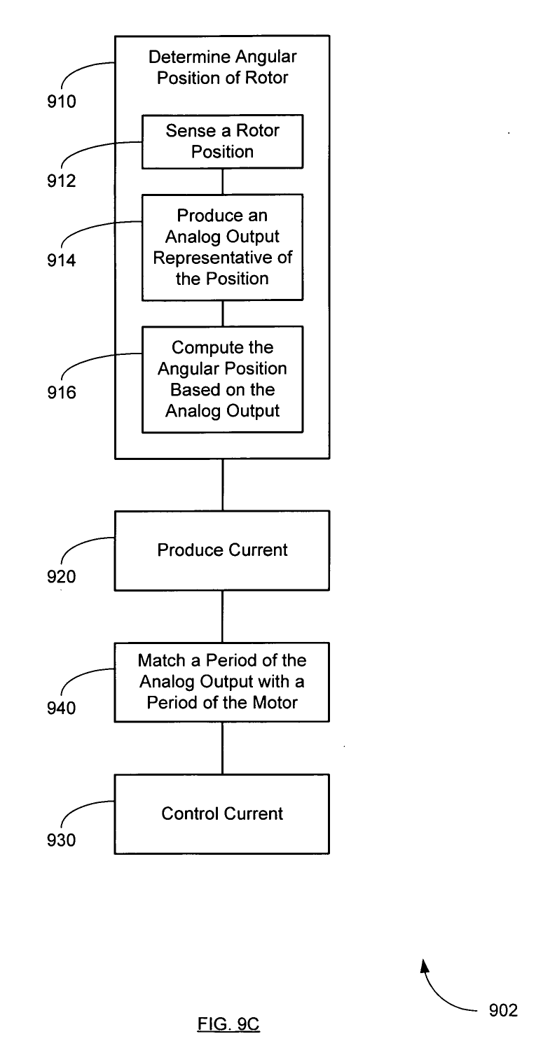

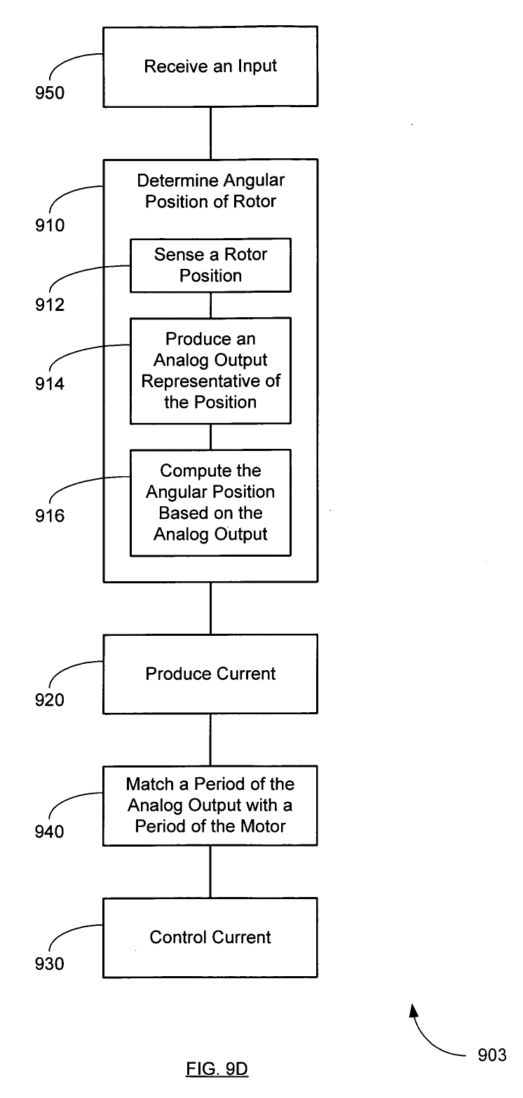

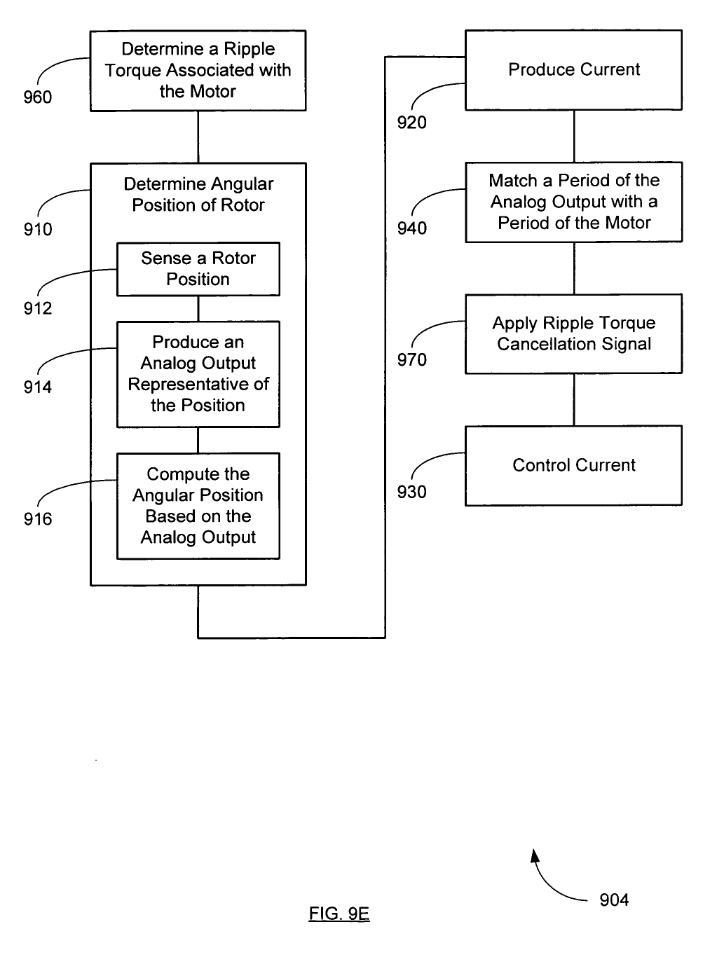

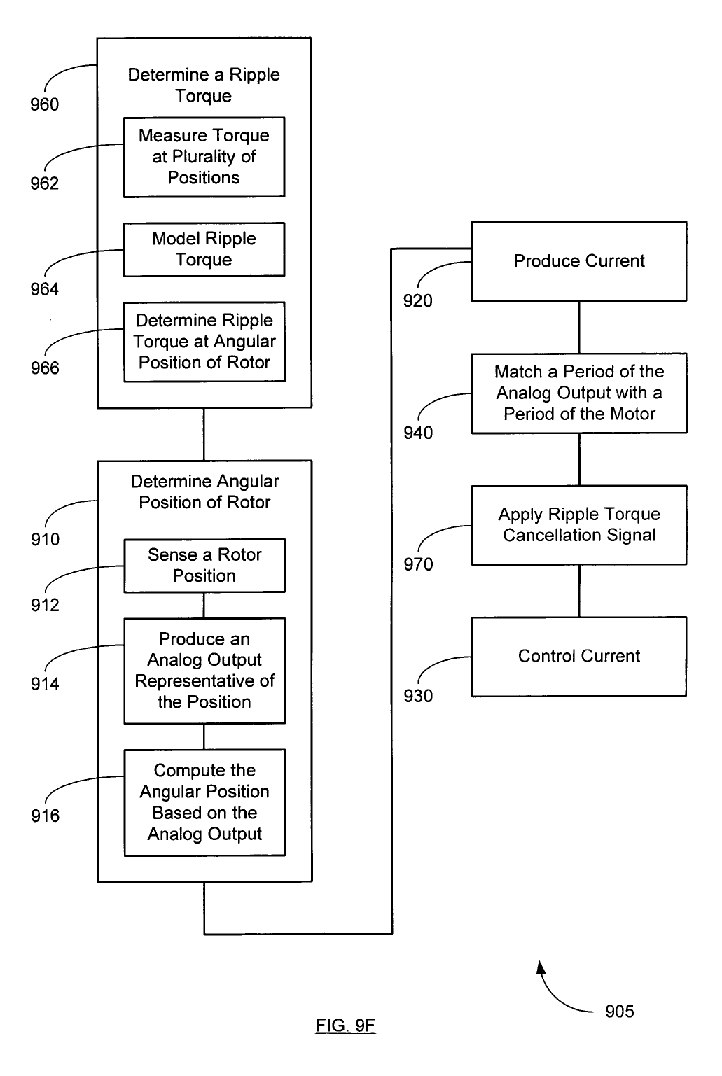

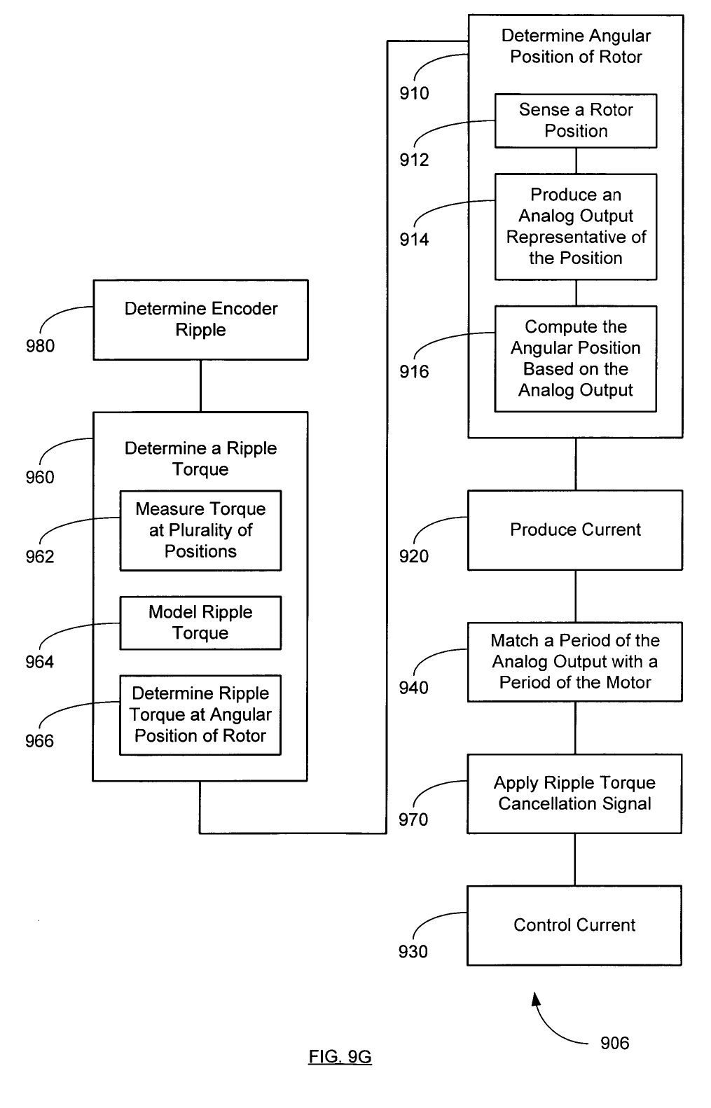

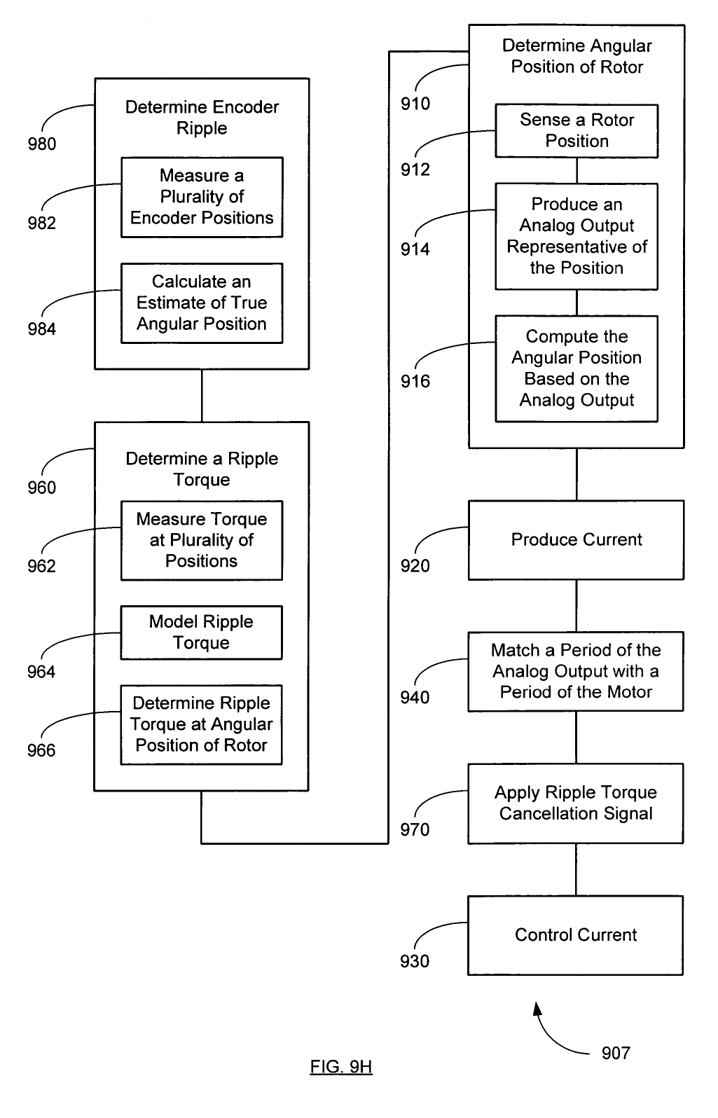

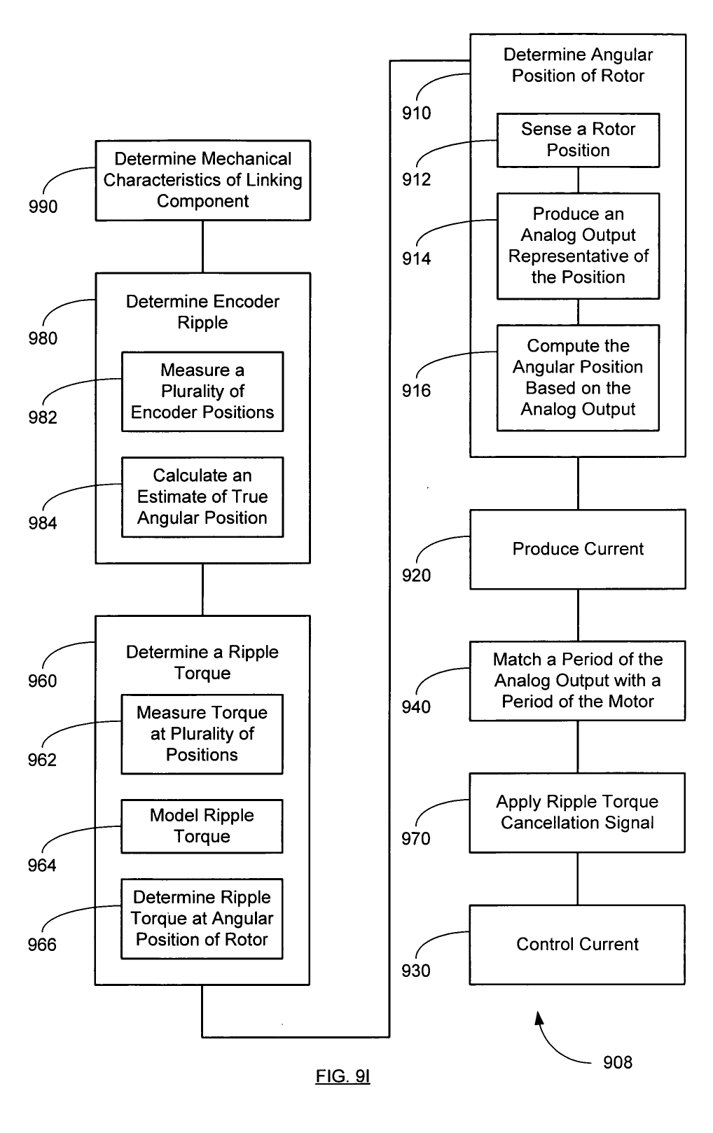

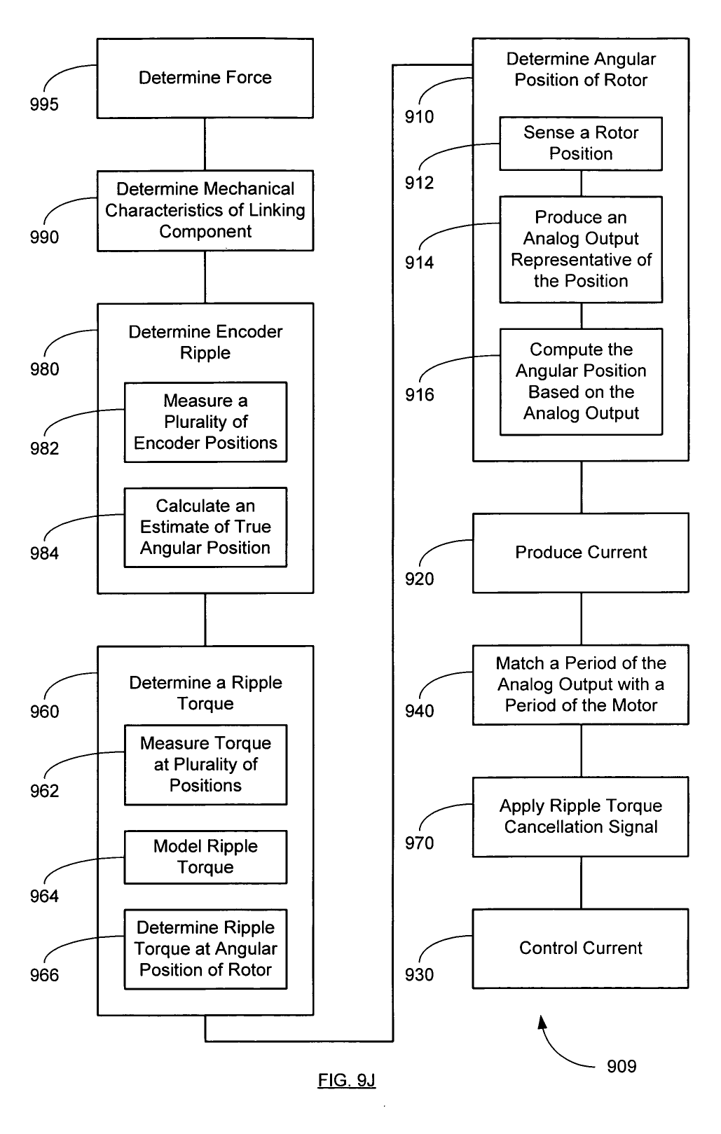

FIG. 9A is a flow diagram illustrating one method 900 of the invention for producing smoother torque from a multi-pole motor by determining an angular position of a rotor 910, producing current 920, and controlling the current 930. FIG. 9B is a flow diagram illustrating another method 901 of the invention for producing smoother torque from a multi-pole motor. The method is similar to that shown in FIG. 9A, except showing in more detail one possible method of determining an angular position of the rotor 910. This detail includes sensing the rotor position 912, producing an analog output representative of the position 914, and computing the angular position based on the analog output 916.

FIG. 9C is a flow diagram illustrating another method 902 of the invention for producing smoother torque from a multi-pole motor, similar to that shown in FIG. 9B, except also including matching a period of an analog output with a period of the motor 940. FIG. 9D is a flow diagram illustrating another method 903 of the invention for producing smoother torque from a multi-pole motor, similar to that shown in FIG. 9C. This method shows receiving an input 950. The received input may modify the controlling of the current 930 so as to respond to the input.

FIG. 9E is a flow diagram illustrating another method 904 of the invention for producing smoother torque from a multi-pole motor, similar to that shown in FIG. 9C, except also including determining a ripple torque 960 associated with the motor and applying a ripple torque cancellation signal 970. In FIG. 9F a flow diagram illustrating another method 905 of the invention for producing smoother torque from a multi-pole motor, similar to that shown in FIG. 9E is shown. This flow diagram shows one possible method of determining the ripple torque 960 which includes measuring torque at a plurality of positions 962, modeling the ripple torque 964, and determining the ripple torque at the angular position of the rotor 966.

FIG. 9G is a flow diagram illustrating another method 906 of the invention for producing smoother torque from a multi-pole motor, similar to that shown in FIG. 9F, except also including determining an encoder ripple 980. The determination of encoder ripple 980 may be used to further vary the current 930 provided to the multi-pole motor. FIG. 9H is a flow diagram illustrating another method 907 of the invention for producing smoother torque from a multi-pole motor, similar to that shown in FIG. 9G, except showing one possible method of determining encoder ripple 980. The method of determining encoder ripple 980 may include measuring a plurality of encoder positions 982 and calculating an estimate of the true angular position of the rotor 984.

FIG. 9I is a flow diagram illustrating another method 908 of the invention for producing smoother torque from a multi-pole motor, similar to that shown in FIG. 9H, except also including determining mechanical characteristics of a linking component 990. FIG. 9J is a flow diagram illustrating another method 909 of the invention for producing smoother torque from a multi-pole motor, similar to that shown in FIG. 9I, except also including determining a force 995, possibly at an input device coupled with the multi-pole motor. In either FIG. 9I or FIG. 9J, the method may respond to mechanical characteristics of a linking component or a determined force by controlling the amount of current 930 which is sent to the multi-pole motor.

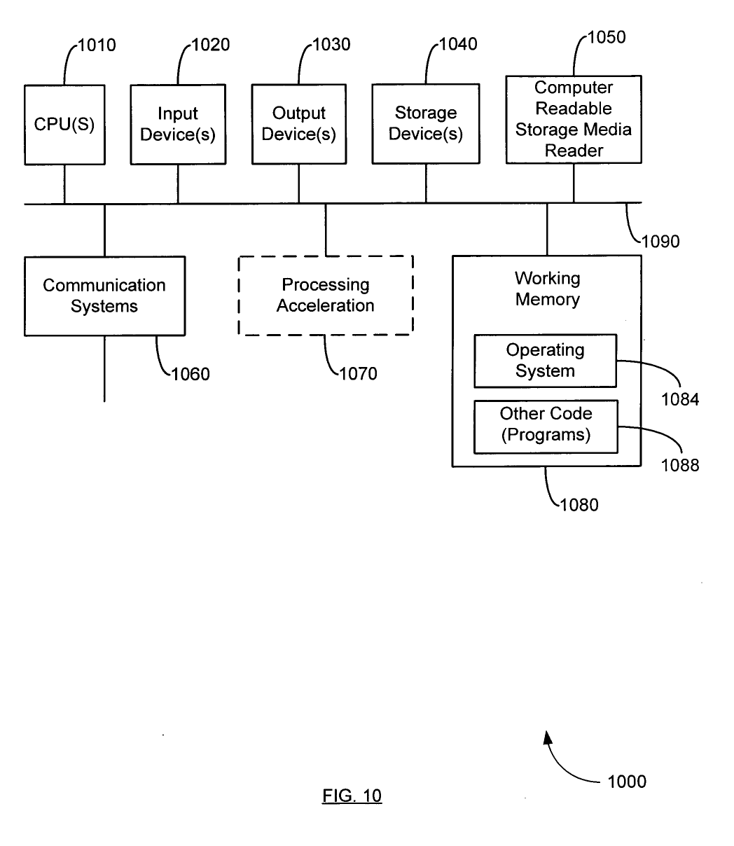

FIG. 10 is an example of a computer system capable of implementing the methods, apparatuses, or particular portions of the methods or apparatuses of the present invention. This example illustrates a computer system 1000 such as may be used, in whole, in part, or with various modifications, to provide at least some portion of the functions of the computers, control systems, control units, sensors, drivers and/or other systems discussed above.

The computer system 1000 is shown comprising hardware elements that may be electrically coupled via a bus 1090. The hardware elements may include one or more central processing units (CPUs) 1010, one or more input devices 1020 (e.g., a mouse, a keyboard, etc.), and one or more output devices 1030 (e.g., a display device, a printer, etc.). The computer system 1000 may also include one or more storage device 1040. Byway of example, storage device(s) 1040 may be disk drives, optical storage devices, solid-state storage devices such as a random access memory (“RAM”) and/or a read-only memory (“ROM”), which can be programmable, flash-updateable and/or the like.

The computer system 1000 may additionally include a computer-readable storage media reader 1050, a communications system 1060 (e.g., a modem, a network card (wireless or wired), an infra-red communication device, etc.), and working memory 1080, which may include RAM and ROM devices as described above. In some embodiments, the computer system 1000 may also include a processing acceleration or real-time processing unit 1070, which can include a DSP, a special-purpose processor and/or the like.

The computer-readable storage media reader 1050 can further be connected to a computer-readable storage medium, together (and, optionally, in combination with storage device(s) 1040) comprehensively representing remote, local, fixed, and/or removable storage devices plus storage media for temporarily and/or more permanently containing computer-readable information. The communications system 1060 may permit data to be exchanged with a network and/or any other computer described above with respect to the system 1000.

The computer system 1000 may also comprise software elements, shown as being currently located within a working memory 1080, including an operating system 1084 and/or other code 1088. It should be appreciated that alternate embodiments of a computer system 1000 may have numerous variations from that described above. For example, customized hardware might also be used and/or particular elements might be implemented in hardware, software (including portable software, such as applets), or both. Further, connection to other computing devices, such as network input/output devices, may be employed.

Software of computer system “1000”may include code 1088 for implementing any or all of the function of the various elements of the architecture as described herein. For example, software, stored on and/or executed by a computer system such as system 1000, can provide at least some of the functions of computers, control systems, control units, sensors, drivers and/or other systems disclosed herein. Methods implementable by software on some of these components have been discussed above.

It should be noted that the methods, systems and devices discussed above are intended merely to be exemplary in nature. It must be stressed that various embodiments may omit, substitute, or add various procedures or components as appropriate. For instance, it should be appreciated that in alternative embodiments, the methods may be performed in an order different than that described, and that various steps may be added, omitted or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow chart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure.

Moreover, as disclosed herein, the terms “storage medium” or “storage device” may represent one or more devices for storing data, including read only memory (ROM), random access memory (RAM), magnetic RAM, core memory, magnetic disk storage mediums, optical storage mediums, flash memory devices or other machine readable mediums for storing information. The term “computer-readable medium” includes, but is not limited to, portable or fixed storage devices, optical storage devices, wireless channels, a sim card, other smart cards, and various other mediums capable of storing, containing or carrying instructions or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be required before the above elements are considered. Accordingly, the above description should not be taken as limiting the scope of the invention, which is defined in the following claims.

What is claimed is:

1. A method of producing a smoother torque from a multi-pole motor, the method comprising:
determining an angular position of a rotor of the multi-pole motor;
producing a current to drive the multi-pole motor, the multi-pole motor configured to produce a torque with substantially sinusoidal characteristics when driven by a steady current; and
controlling the current based on the determined angular position, wherein the current is controlled to produce a smoother torque without the substantially sinusoidal characteristics.

2. The method of claim 1, wherein the multi-pole motor comprises a stepper motor.

3. The method of claim 1, wherein determining the angular position comprises:
sensing a rotor position of the multi-pole motor;
producing an analog output representative of the sensed rotor position; and
computing the angular position based at least in part on the analog output.

4. The method of claim 3, wherein the analog output comprises a first sinusoidal voltage and second sinusoidal voltage in quadrature, wherein each sinusoidal voltage represents a different sensed rotor position of the multi-pole motor.

5. The method of claim 3, further comprising:
matching a period of the analog output with an electrical period of the multi-pole motor.

6. The method of claim 3, further comprising:
receiving an input at an input device coupled with the multi-pole motor, the received input causing a change in the rotor position; and
controlling the current to drive the multi-pole motor to produce a force at the input device responsive to the received input.

7. The method of claim 1, further comprising:
determining a ripple torque associated with the multi-pole motor; and
applying a ripple torque cancellation signal to vary the current and thereby substantially cancel the determined ripple torque.

8. The method of claim 7, wherein determining the ripple torque comprises:
measuring a torque necessary to hold each of a plurality of positions of the multi-pole motor;
modeling ripple torque as a function of the measured torque; and
determining the ripple torque at the angular position based on the modeled ripple torque.

9. The method of claim 7, wherein the ripple torque associated with the multi-pole motor is caused by a selection from the group consisting of:
non-optimized tooth profile in a stator of the multi-pole motor;
non-optimized tooth profile in the rotor of the multi-pole motor;
variation between tooth profiles in the stator of the multi-pole motor;
variation between tooth profiles in the rotor of the multi-pole motor;
errors in the angular position determination; and
any combination thereof.

10. The method of claim 1, further comprising:
determining an encoder ripple associated with the determination of the angular position; and
varying the current to unwarp the determined encoder ripple.

11. The method of claim 10, wherein determining the encoder ripple comprises:
measuring a plurality of encoder positions over an encoder period while the multi-pole motor is at a substantially constant velocity, the measure taken while the multi-pole motor is off-line; and
calculating an estimate of a true angular position based on the measured plurality of encoder positions during real-time operation.

12. The method of claim 10, wherein the encoder ripple associated with the determination of the angular position is caused by a selection from the group consisting of:
variations between the optical reflectance of an encoder disk used to determine angular position;
variations between the electrical properties of an optical sensor used to determine angular position;
variations between the magnetic properties of a Hall sensor used to determine angular position;
variations between the electrical properties of a Hall sensor used to determine angular position;
eccentricity in mounting an encoder disk used to determine angular position;
eccentricity in mounting a Hall sensor component used to determine angular position;
the planarity of the encoder disk being different than the planarity of the sensor used to determine angular position;
the plane of the encoder disk not being perfectly perpendicular to the shaft of the multi-pole motor; and
physical manufacturing defects in the encoder disk.

13. The method of claim 1, further comprising:
determining the mechanical characteristics of a linking component coupling the multi-pole motor with an input device; and
varying the current produced based at least in part on the determined mechanical characteristics.

14. The method of claim 13, wherein the mechanical characteristics comprise a function of a spring coefficient of the linking component.

15. The method of claim 1, further comprising:
determining a force received at a haptic device coupled with the multi-pole motor; and
varying the current to create a force on the haptic device responsive to the determined force.

16. An apparatus for producing a smoother torque from a multi-pole motor, the apparatus comprising:
the multi-pole motor configured to produce a torque with substantially sinusoidal characteristics when driven by a steady current; and
a control unit coupled with the multi-pole motor, and configured to:
determine an angular position of a rotor of the multi-pole motor;
produce a current to drive the multi-pole motor; and
control the current based on the determined angular position, wherein the current is controlled to produce a smoother torque without the substantially sinusoidal characteristics.

17. The apparatus of claim 16, wherein the multi-pole motor comprises a stepper motor.

18. The apparatus of claim 16, further comprising:
one or more additional multi-pole motors; and
a user interface coupled with each of the multi-pole motors,
wherein,
the control unit produces a current to drive each of the one or more additional multi-pole motors; and
the multi-pole motor and each of the one or more additional multi-pole motors are coupled with the user interface.

19. The apparatus of claim 16, further comprising:
a sensor to identify a rotor position of the multi-pole motor; and
a circuit to produce an analog output representative of the identified rotor position,
wherein the control unit determines the angular position by computing the angular position based at least in part on the analog output.

20. The apparatus of claim 19, wherein the sensor comprises an optical encoder.

21. The apparatus of claim 20, wherein the optical encoder comprises:
a reflective disk with a plurality of lines;
at least one photosensor configured to signal a change in position by reading the reflective disk as it spins, the spin caused by movement at the input device; and
the circuit.

22. The apparatus of claim 19, further comprising:
an input device coupled with the multi-pole motor configured to receive input causing a change in the rotor position,
wherein the control unit further controls the current to drive the multi-pole motor to produce a force at the input device responsive to the received input.

23. The apparatus of claim 25, wherein,
the input device comprises a haptic interface.

24. The apparatus of claim 16, wherein the control unit comprises;
a control system; and
a pulse width modulation (PWM) driver coupled with the control system, and configured to produce the current by controlling a switching frequency.

25. The apparatus of claim 16, wherein the control unit is configured to:
determine a ripple torque associated with the multi-pole motor; and
apply a ripple torque cancellation signal to vary the current and thereby substantially cancel the determined ripple torque.

26. The apparatus of claim 25, wherein the control unit is configured to:
measure a torque necessary to hold each of a plurality of positions of the multi-pole motor; and
model ripple torque as a function of the measured torque,
wherein the control unit determines the ripple torque at the angular position based on the modeled ripple torque.

27. The apparatus of claim 16, wherein the control unit is configured to:
determine an encoder ripple associated with the determination of the angular position; and
vary the current to unwarp the determined encoder ripple.

28. The apparatus of claim 27, wherein the control unit is further configured to:
measure a plurality of encoder positions over an encoder period while the multi-pole motor is at a substantially constant velocity, the measure taken while the multi-pole motor is off-line; and
determine an encoder ripple by calculating an estimate of a true angular position based on the measured plurality of encoder positions during real-time operation.

29. An apparatus for producing a smoother torque from a multi-pole motor, the apparatus comprising:
means for determining an angular position of a rotor of the multi-pole motor;
means producing a current to drive the multi-pole motor, the multi-pole motor configured to produce a torque with substantially sinusoidal characteristics when driven by a steady current; and
means for controlling the current based on the determined angular position, wherein the current is controlled to produce a smoother torque without the substantially sinusoidal characteristics.

30. The apparatus of claim 29, further comprising:
means for receiving an input at an input device coupled with the multi-pole motor, the received input causing a change in the rotor position; and
means for controlling the current to drive the multi-pole motor to produce a force at the input device responsive to the received input.

31. The apparatus of claim 29, further comprising:
means for determining a ripple torque associated with the multi-pole motor; and
means for applying a ripple torque cancellation signal to vary the current and thereby substantially cancel the determined ripple torque.

32. The apparatus of claim 29, further comprising:
means for determining an encoder ripple associated with the means for determination of the angular position; and
means for varying the current to unwarp the determined encoder ripple.
